(19) United States
(12) Patent Application Publication
(10) Pub. No.: US 2024/0140137 A1
(43) Pub. Date: May 2, 2024

(54) APPARATUS AND METHODS FOR FLOATING REGISTER WHEEL

(71) Applicant: Vorsteiner North America, Garden Grove, CA (US)

(72) Inventor: Peter Nam, Irvine, CA (US)

(21) Appl. No.: 18/482,784

(22) Filed: Oct. 6, 2023

Related U.S. Application Data
(60) Provisional application No. 63/381,513, filed on Oct. 28, 2022.

(51) Int. Cl. B60B 19/10; B60B 3/10

(52) U.S. Cl. CPC B60B 19/10; B60B 3/10; B60B 2900/513

(57) ABSTRACT

An apparatus and methods are provided for a floating register wheel to provide cooling to brake system components of a vehicle. The floating register wheel includes a barrel for mounting a tire, an outboard face for fastening the barrel to a wheel hub of the vehicle, and vents in the outboard face to provide cooling to the brake system components. The outboard face includes a surface register for fastening the outboard face to the barrel and a floating register that includes the vents. Spokes join the surface register and the floating register to a hub for fastening the wheel to the vehicle. The floating register is outboard of the surface register to provide openings between the floating register and the surface register. The openings allow air to flow from the vents to openings between the spokes to extract heated air from the brake system components during operating the vehicle.

### FIELD

Embodiments of the present disclosure generally relate to the field of vehicle wheels. More specifically, embodiments of the disclosure relate to an apparatus and methods for a floating register wheel for providing cooling to brake system components of a vehicle.

### PRIORITY

This application claims the benefit of and priority to U.S. Provisional Application No. 63/381,513, filed Oct. 28, 2022, which is incorporated in its entirety herein.

### BACKGROUND

Modern automotive vehicles generally include hydraulically actuated brakes on both the front and rear wheels of the vehicle. In many vehicles, the front wheels include disc brakes while the rear wheels include drum brakes. In the case of both disc and drum brakes, when a vehicle operator steps on the brake pedal, hydraulic fluid causes friction material pads/linings to engage the discs and drums to decrease rotation of the wheels of the vehicle. Under continued application of the brake pedal, friction applied to the discs and drums eventually causes the wheels to stop rotating, thereby bringing the vehicle to a stop.

Friction during applying the brakes generates significant heat. During normal driving, air flow around a moving vehicle generally provides a sufficient degree of cooling of brake disc and brake drum surfaces. Aggressive driving and braking, such as occurs during racing, can overheat the brakes, causing the brakes to burn and start smoking, as well as giving rise to squealing due to the brake pads and rotors glazing over. Brake pads and linings have an optimal operating temperature range. Above this temperature range, binders and materials in the pads and linings can melt forming lubrication on the brake surfaces rather than friction. As materials within the pads and linings evaporate or ‘gas out’ this can form a layer on the surfaces of the pads and linings that provides reduced friction, thereby creating glazed surfaces as the brakes later cool down. The brake pedal will lose some of its tactility and will feel more solid, but without giving much braking power.

As such, there is a continuous desire to develop components and systems that provide improved cooling to brake system components, particularly during hard driving such as occurs during racing and off-roading.

### SUMMARY

An apparatus and methods are provided for a floating register wheel to provide cooling to brake system components of a vehicle. The floating register wheel includes a barrel for mounting a tire, an outboard face for fastening the barrel to a wheel hub of the vehicle, and vents in the outboard face to provide cooling to the brake system components. The outboard face includes a surface register for fastening the outboard face to the barrel and a floating register that includes the vents. Spokes join the surface register and the floating register to a hub for fastening the wheel to the vehicle. The floating register is outboard of the surface register to provide openings between the floating register and the surface register. The openings allow air to flow from the vents to openings between the spokes to extract heated air from the brake system components during operating the vehicle.

In an exemplary embodiment, an outboard face for a wheel of a vehicle comprises: a surface register for fastening the outboard face to a barrel; a floating register including vents to provide cooling to brake system components of the vehicle; spokes joining the surface register and the floating register; and a hub for fastening the wheel to the vehicle.

In another exemplary embodiment, the barrel comprises an outboard rim that is coupled with an inboard rim. In another exemplary embodiment, the outboard rim and the inboard rim are separate components that are welded together to form the barrel. In another exemplary embodiment, the barrel is forged as a single component.

In another exemplary embodiment, the outboard face is configured to be fastened onto a lip disposed around a perimeter of an inner surface of the barrel. In another exemplary embodiment, the surface register includes a multiplicity of threaded holes for mounting the outboard face onto the barrel. In another exemplary embodiment, the threaded holes are configured to receive hardware fasteners.

In another exemplary embodiment, the spokes are configured to position the floating register farther outboard than the surface register so as to establish openings between the floating register and the surface register. In another exemplary embodiment, the openings provide fluid communication between the vents and openings between the spokes. In another exemplary embodiment, the vents are configured to cause the airflow through the openings to extract heated air from inside the barrel.

In an exemplary embodiment, a floating register wheel for a vehicle comprises: a barrel for mounting a tire; an outboard face for fastening the barrel to a wheel hub of a vehicle; and vents disposed in a floating register to provide cooling to brake system components of the vehicle.

In another exemplary embodiment, the barrel comprises an outboard rim that is coupled with an inboard rim. In another exemplary embodiment, the outboard rim and the inboard rim are separate components that are welded together to form the barrel. In another exemplary embodiment, the barrel is forged as a single component.

In another exemplary embodiment, the outboard face is configured to be fastened onto a lip disposed around a perimeter of an inner surface of the barrel. In another exemplary embodiment, the outboard face includes a surface register that includes a multiplicity of threaded holes for mounting the outboard face onto the barrel. In another exemplary embodiment, the threaded holes are configured to receive hardware fasteners.

In another exemplary embodiment, the outboard face includes a surface register for fastening the outboard face to a barrel; a floating register including vents to provide cooling to brake system components of the vehicle; spokes joining the surface register and the floating register; and a hub for fastening the wheel to the vehicle.

In another exemplary embodiment, the spokes are configured to position the floating register farther outboard than the surface register so as to establish openings between the floating register and the surface register. In another exemplary embodiment, the openings provide fluid communication between the vents and openings between the spokes. In another exemplary embodiment, the vents are configured to cause the airflow through the openings to extract heated air from inside the barrel.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an isometric view of an exemplary embodiment of a floating register wheel for providing cooling to brake system components of a vehicle, according to the present disclosure;

FIG. 2 illustrates a front isometric exploded view of an exemplary embodiment of a floating register wheel, in accordance with the present disclosure;

FIG. 3 illustrates a rear isometric exploded view of an exemplary embodiment of a floating register wheel, in accordance with the present disclosure;

FIG. 4 illustrates a cross-sectional view of a barrel with an exemplary embodiment of an outboard face installed onto a lip of the barrel, according to the present disclosure;

FIG. 5 illustrates a front plan view of an exemplary embodiment of an outboard face, according to the present disclosure;

FIG. 6 illustrates a rear plan view of the outboard face of FIG. 5, in accordance with the present disclosure;

FIG. 7 illustrates a front plan view of an exemplary embodiment of an outboard face, according to the present disclosure; and

FIG. 8 illustrates a front plan view of an exemplary embodiment of an outboard face that includes extended vents in accordance with the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the floating register wheel and methods disclosed herein may be practiced without these specific details. In other instances, specific numeric references such as “first cooling vent,” may be made. However, the specific numeric reference should not be interpreted as a literal sequential order but rather interpreted that the “first cooling vent” is different than a “second cooling vent.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Modern automotive vehicles generally include hydraulically actuated brakes on the front and rear wheels of the vehicle. Friction during applying the brakes generates significant heat. During normal driving, air flow around the vehicle generally provides cooling to brake system components. Aggressive braking, such as occurs during racing and off-roading, can overheat the brakes, causing reduced brake performance and potentially permanent damage to brake system components. As such, there is a continuous desire to provide greater cooling to brake components during hard driving. Embodiments presented herein provide floating register wheels for providing cooling to brake system components during hard driving.

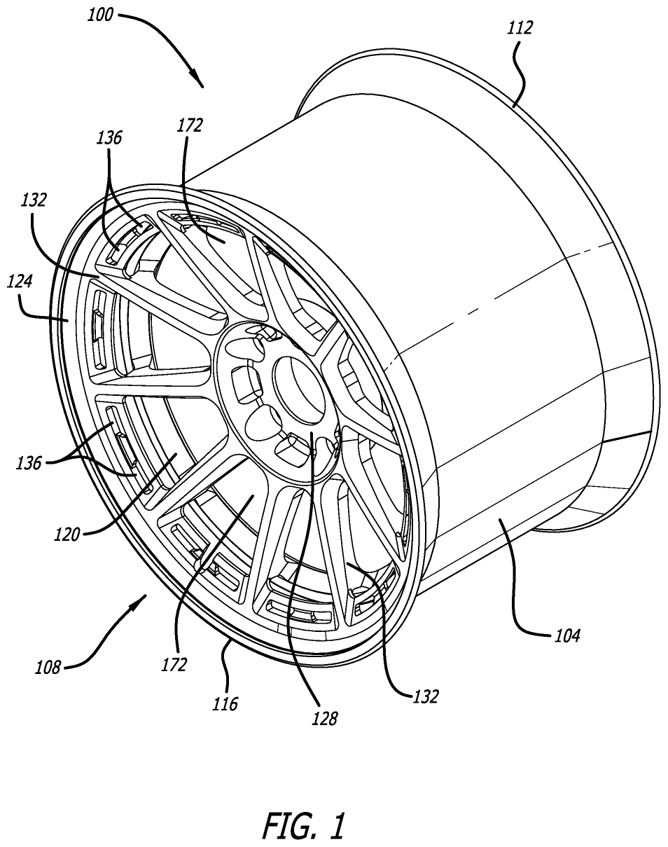

FIG. 1 illustrates an isometric view of an exemplary embodiment of a floating register wheel 100 for providing cooling to brake system components of a vehicle, according to the present disclosure. The floating register wheel 100 includes a barrel 104 for supporting a tire (not shown) and an outboard face 108 for fastening the barrel 104 to a wheel hub (not shown) of the vehicle. The barrel 104 is a cylindrical member having an inboard flange 112 and an outboard flange 116 for respectively retaining an inboard bead and an outboard bead of the tire. The outboard face 108 is a broadly disc-shaped member that may be coupled with the barrel 104 by way of suitable fasteners, as described herein. In the illustrated embodiment, the outboard face 108 comprises a surface register 120 and a floating register 124 that are attached to a central hub 128 by way of multiple spokes 132. The registers 120, 124 and the spokes 132 can be implemented in a variety of arrangements for aesthetic appeal, without limitation. The floating register 124 includes a multiplicity of vents 136 that are peripherally arranged on the outboard face 108. The vents 136 are configured to provide cooling to brake system components of the vehicle, as described herein.

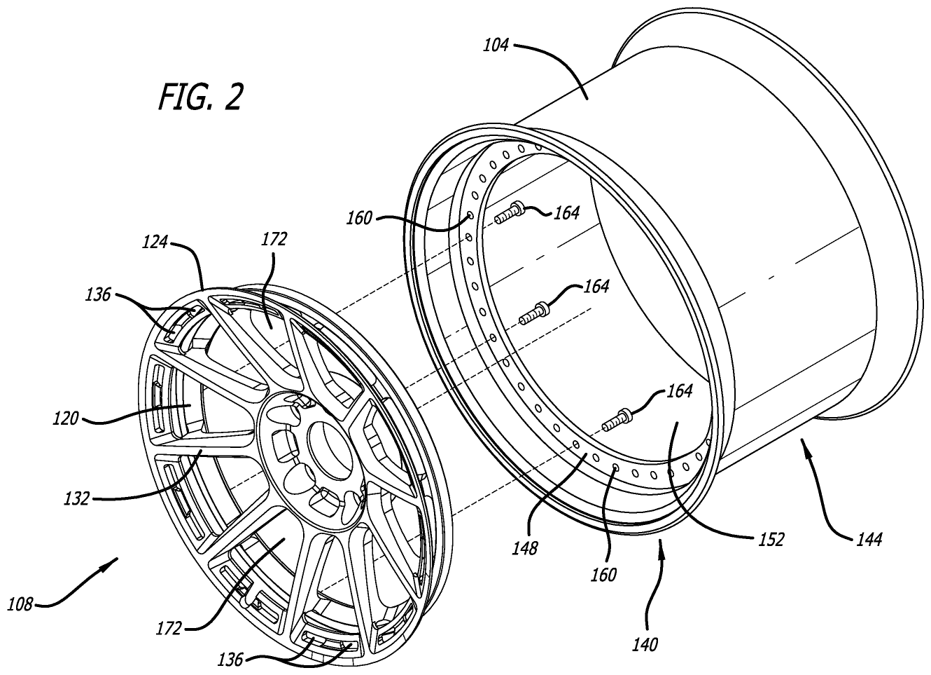

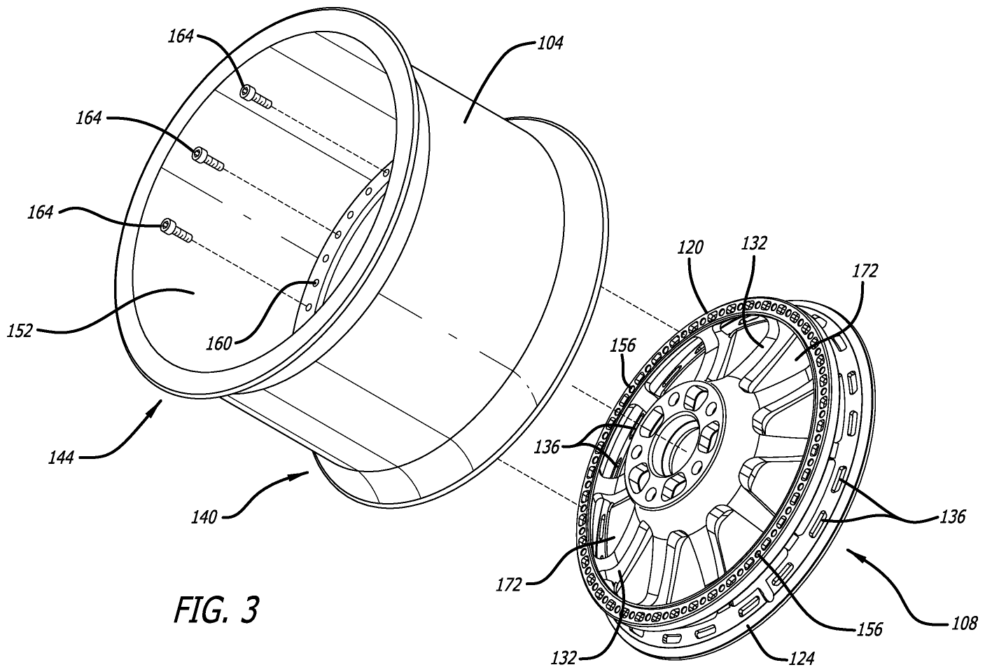

FIGS. 2 and 3 illustrate isometric exploded views of the floating register wheel 100 in absence of a tire. As shown, the barrel 104 generally comprises an outboard rim 140 that is coupled with an inboard rim 144. As will be recognized, the outboard rim 140 and the inboard rim 144 may be separate components that are welded together to form the barrel 104, or the barrel 104 may be forged as a single component. In some embodiments, manufacturing the outboard rim 140 and the inboard rim 144 separately before joining them to form a single component generally simplifies forming the barrel 104. It is contemplated, however, that the outboard rim 140 and the inboard rim 144 may be joined by means other than welding, without straying beyond the scope of the present disclosure.

In the illustrated embodiment, the outboard face 108 is configured to be fastened onto a lip 148 disposed around a perimeter of an inner surface 152 of the barrel 104. As best shown in FIG. 3, the surface register 120 includes a multiplicity of threaded holes 156 configured for mounting the outboard face 108 onto the barrel 104. The threaded holes 156 may be sized and aligned with holes 160 disposed around the lip 148 such that fasteners 164 (e.g., bolts) can be inserted through the holes 160 and threadably engaged with the holes 156 of the surface register 120. As will be appreciated, the outboard face 108 may be fixedly attached to the barrel 104 by suitably tightening the fasteners 164 into the threaded holes 156 of the surface register 120. It is contemplated, however, that the coupling of the outboard face 108 to the barrel 104 is not to be limited to using fasteners 164, but rather any of various suitable fasteners may be used to couple the outboard face 108 to the barrel 104, without limitation. Further, in some embodiments, the surface register 120 may be welded onto the lip 148 or directly onto the inner surface 152 of the barrel 104, in lieu of using the fasteners 164, without limitation.

As will be appreciated, there may be applications wherein relatively reduced weight of the floating register wheel 100 is desired. It is contemplated that the overall weight of the wheel 100 may be reduced by forming either or both of the barrel 104 and the outboard face 108 of out of a lightweight material such as, by way of non-limiting example, aluminum, various metallic alloys, carbon fiber, and other suitable nonmetallic materials. In some embodiments, the weight of the wheel can be reduced by forming a composite assembly comprising different materials. For example, in one embodiment, aluminum or a suitable metallic alloy may be used for either or both of the outboard rim 140 and the inboard rim 144, while carbon fiber may be used for either or both of the surface register 120 and the floating register 124. Other suitable material combinations will be apparent to those skilled in the art. Further, the sizes and locations of the vents 136 may be altered so as to decrease the weight of the wheel 100, without limitation.

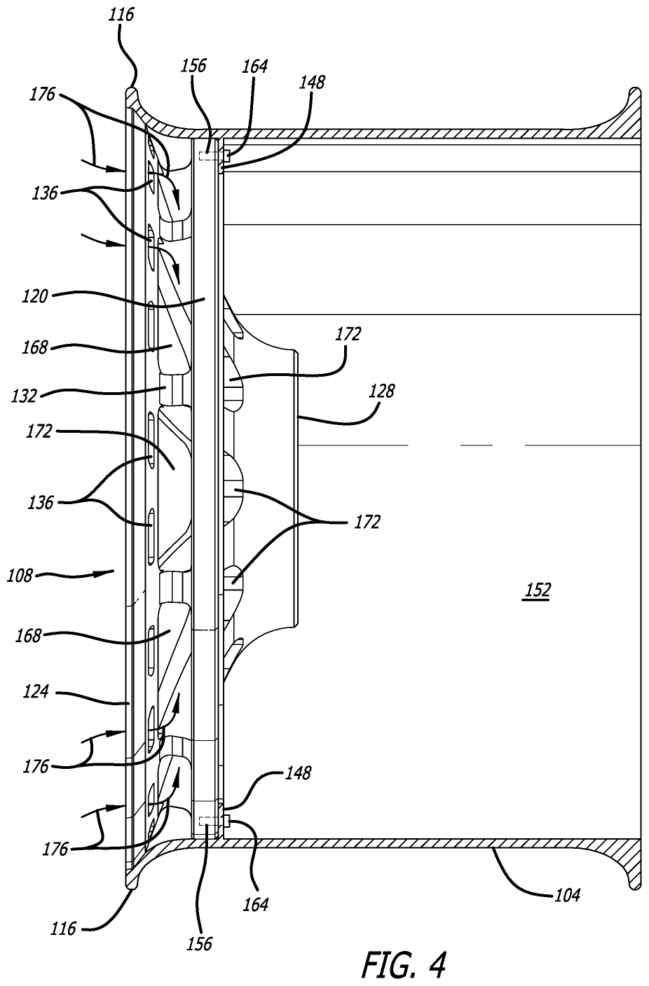

FIG. 4 illustrates a cross-sectional view of the barrel 104 with an exemplary embodiment of the outboard face 108 installed onto the lip 148 of the barrel 104. As described hereinabove, a multiplicity of fasteners 164 are tightened into threaded holes 156 such that the surface register 120 is fixated to the lip 148. As shown in FIG. 4, the floating register 124 is disposed adjacent to the outboard flange 116 of the barrel 104. The floating register 124 is not fastened directly to the barrel 104, but rather the floating register 124 is coupled to the barrel 104 by way of spokes 132 that join the surface register 120 and the floating register 124.

It is contemplated that extending the floating register 124 so close the outboard flange 116 of the barrel 104 can be used to give the wheel 100 a desirably larger appearance. In one exemplary embodiment, the floating register 124 is used to give a wheel 100 having a physical diameter of about 18 inches an apparent diameter of about 19 inches without the wheel 100 having the weight typically associated with 19-inch wheels. As such, the floating register 124 may be used to form relatively reduced weight wheels.

As shown in FIG. 4, the spokes 132 are configured to position the floating register 124 farther outboard than the surface register 120, thereby establishing openings 168 between the floating register 124 and the surface register 120. The openings 168 provide fluid communication between the vents 136 and openings 172 disposed between the spokes 132 (see FIGS. 1-3). It is contemplated that during operation of the floating register wheel 100, an airstream 176 enters through the peripheral vents 136 and is directed through the openings 168, 172. As such, the airstream 176 provides an inflow of outside air to provide cooling to brake system components of the vehicle. Further, in some embodiments, the vents 136 may be configured to cause the airstream 176 to provide an outflow of heated air from inside the barrel 104 by way of the openings 168, 172. In such embodiments, the vents 136 and the openings 168, 172 provide cooling to brake system components by essentially extracting the heated air from the brake system components.

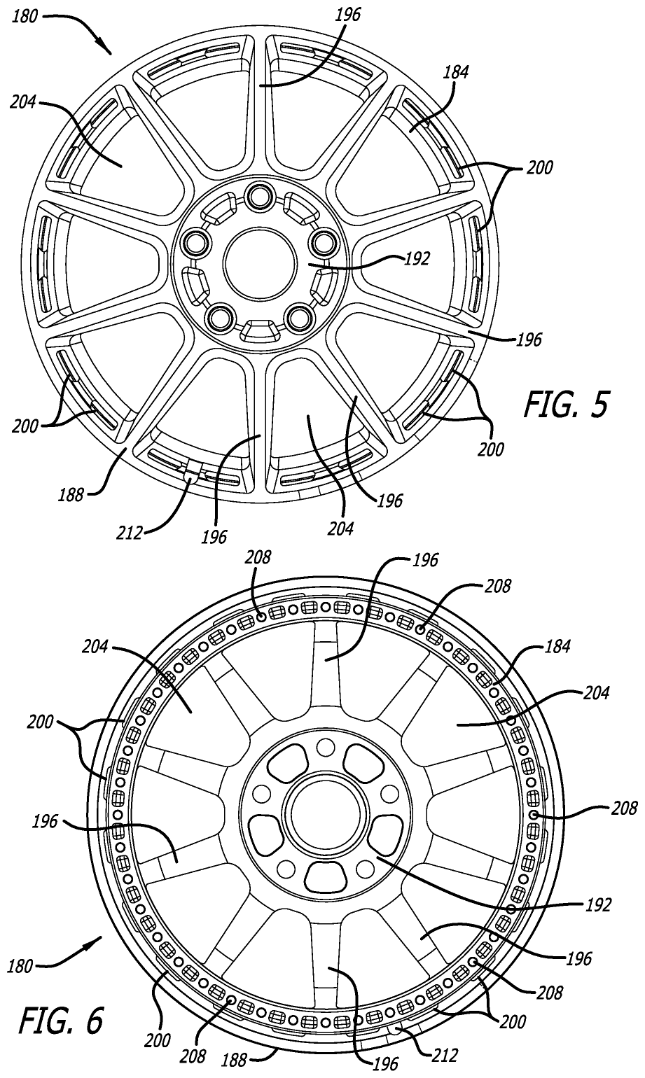

FIG. 5 illustrates a front plan view of an exemplary embodiment of an outboard face 180, according to the present disclosure. FIG. 6 illustrates a rear plan view of the outboard face 180 of FIG. 5. The outboard face 180 comprises a surface register 184 and a floating register 188 that are attached to a central hub 192 by way of multiple spokes 196. The floating register 188 includes a multiplicity of vents 200 that are arranged around the circumference of the floating register 188. The vents 200 are in fluid communication with openings disposed between the surface register 184 and the floating register 188 and openings 204 between the spokes 196. The vents 200 and the openings 204 are configured to cause an airstream, such as the airstream 176 shown in FIG. 4, to remove heat from inside a barrel, such as the barrel 104, to which the outboard face 180 may be fastened. As such, the outboard face 180 is configured to provide cooling to brake system components of a vehicle, as described herein.

Moreover, as best shown in FIG. 6, the outboard face 180 includes a multiplicity of threaded holes 208 arranged around a rearward surface of the surface register 184. The threaded holes 208 generally are configured for mounting the outboard face 180 onto a barrel, such as the barrel 104 of FIG. 1. The threaded holes 208 may be sized and positioned to align with holes 160 (see FIGS. 2-3) disposed around the lip 148 such that fasteners 164 may be inserted through the holes 160 and engaged with the threaded holes 208 of the surface register 184. Further, the floating register 188 includes a valve stem gap 212 configured to accommodate a valve stem protruding from the barrel 104. Once the valve stem extends through the valve stem gap 212 and the fasteners 164 are engaged with the threaded holes 208, the outboard face 180 can be fastened onto the barrel 104 by suitably tightening the fasteners 164 into the threaded holes 208 of the surface register 184. As mentioned hereinabove, however, the coupling of the outboard face 180 to the barrel 104 is not to be limited to using fasteners 164, but rather any of various suitable fasteners may be used to couple the outboard face 180 to the barrel 104, without limitation. Further, in some embodiments, the surface register 184 may be welded to the lip 148 or directly to the interior surface 152 of the barrel 104, without limitation.

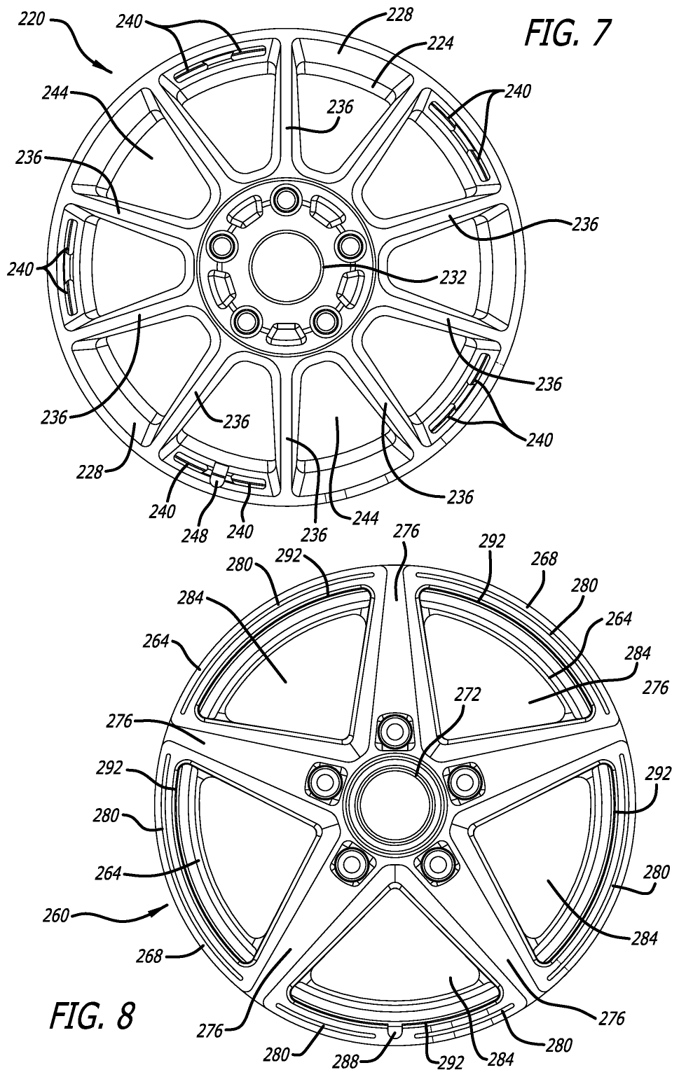

FIG. 7 illustrates a front plan view of an exemplary embodiment of an outboard face 220, according to the present disclosure. Similar to the outboard face 180, shown in FIG. 5, the outboard face 220 comprises a surface register 224 and a floating register 228 that are attached to a concentric hub 232 by way of multiple spokes 236. In general, the spokes 236 position the floating register 228 farther outboard than the surface register 224 to establish openings between the floating register 228 and the surface register 224. The openings provide airflow between a multiplicity of vents 240 and openings 244 disposed between the spokes 236.

With continuing reference to FIG. 7, the vents 240 can be arranged around the floating register 288 in various desirable arrangements, without limitation. For example, in the illustrated embodiment, two vents 240 are disposed in portions of the floating register 228 between alternating pairs of spokes 236. As such, the outboard face 220 includes half as many vents as the outboard face 180 shown in FIG. 5. Other arrangements of the vents 240 will be apparent to those skilled in the art. Further, as described with respect to preceding embodiments, the vents 240 are in fluid communication with openings disposed between the surface register 224 and the floating register 228 and the openings 244 between the spokes 236. The vents 240 and the openings 244 are configured to cause an airstream, such as the airstream 176 shown in FIG. 4, to remove heat from inside a barrel to which the outboard face 220 is fastened. To this end, the outboard face 220 is configured to provide cooling to brake system components of a vehicle, as described herein.

As with the embodiments of FIGS. 1-6, the surface register 224 is configured to be fastened or otherwise attached to a barrel, such as the barrel 104 of FIG. 1. In some embodiments, the surface register 224 includes a multiplicity of threaded holes (not shown) configured to receive fasteners 164 (see FIGS. 2-3), such as bolts, for coupling the surface register 224 to the lip 148 of the barrel 104. The threaded holes may be sized and aligned with holes 160 (see FIGS. 2-3) disposed around the lip 148 such that fasteners 164 can be inserted through the holes 160 and engaged with the threaded holes of the surface register 224. Further, the floating register 228 includes a valve stem gap 248 to accommodate a valve stem protruding from the barrel 104.

Once the valve stem gap 248 is aligned with the valve stem and the fasteners 164 are engaged with the surface register 224, the outboard face 220 can be fastened onto the barrel 104 by suitably tightening the fasteners 164. As mentioned hereinabove, however, the coupling of the outboard face 220 to the barrel 104 is not to be limited to using fasteners 164, but rather any of various suitable fasteners may be used to couple the outboard face 220 to the barrel 104. In some embodiments, the surface register 224 may be welded to the lip 148 or directly onto the interior surface of the barrel 104, without limitation.

FIG. 8 illustrates a front plan view of an exemplary embodiment of an outboard face 260, according to the present disclosure. Similar to the outboard face 180, shown in FIG. 5, the outboard face 260 comprises a surface register 264 and a floating register 268 that are attached to a concentric hub 272 by way of multiple spokes 276. The spokes 276 position the floating register 268 farther outboard than the surface register 264 to establish openings 292 between the floating register 268 and the surface register 264. The openings 292 provide fluid communication between an extended vent 280 and an opening 284 disposed between each pair of the spokes 276.

As shown in FIG. 8, the vents 280 generally are arranged around the circumference of the floating register 288. It is contemplated that the vents 280 may be disposed in various desirable arrangements, without limitation. For example, in the illustrated embodiment of FIG. 8, a single extended vent 280 is disposed in the portion of the floating register 268 between each pair of spokes 276. As such, the amount of open space between the surface and floating registers 264, 268 is substantially maximized. Further, the vents 280 are in fluid communication with the openings 284, 292 between the spokes 276. The vents 280 and the openings 284, 292 are configured to cause an airstream, such as the airstream 176 shown in FIG. 4, to remove heat from inside a barrel to which the outboard face 260 is fastened. As such, the outboard face 260 is configured to provide cooling to brake system components of a vehicle, as described herein.

As will be appreciated, the surface register 264 is configured to be fastened or otherwise attached to a barrel, such as the barrel 104 shown in FIG. 1. In some embodiments, the surface register 264 includes a multiplicity of threaded holes (not shown) configured to receive fasteners 164, such as bolts, for coupling the surface register 264 to a lip 148 (see FIGS. 2-3) comprising the barrel 104. The threaded holes may be sized and aligned with holes 160 (see FIGS. 2-3) disposed around the lip 148 such that the fasteners 164 may be inserted through the holes 160 and engaged with the threaded holes of the surface register 224. As further shown in FIG. 8, the floating register 268 includes a valve stem gap 288 to accommodate a valve stem protruding from the barrel 104.

Once the valve stem gap 288 is aligned with the valve stem and the fasteners 164 are engaged with the surface register 264, the outboard face 260 can be fastened onto the barrel 104 by suitably tightening the fasteners 164. As mentioned hereinabove, however, the coupling of the outboard face 260 to the barrel 104 is not to be limited to using fasteners 164, but rather any of various suitable fasteners may be used to couple the outboard face 260 to the barrel 104. Further, in some embodiments, the surface register 264 may be welded to the lip 148 or directly onto the interior surface of the barrel 104, without limitation.

While the floating register wheel and methods have been described in terms of particular variations and illustrative figures, those of ordinary skill in the art will recognize that the floating register wheel is not limited to the variations or figures described. In addition, where methods and steps described above indicate certain events occurring in certain order, those of ordinary skill in the art will recognize that the ordering of certain steps may be modified and that such modifications are in accordance with the variations of the floating register wheel. Additionally, certain of the steps may be performed concurrently in a parallel process, when possible, as well as performed sequentially as described above. To the extent there are variations of the floating register wheel, which are within the spirit of the disclosure or equivalent to the floating register wheel found in the claims, it is the intent that this patent will cover those variations as well. Therefore, the present disclosure is to be understood as not limited by the specific embodiments described herein, but only by scope of the appended claims.

What is claimed is:

1. An outboard face for a wheel of a vehicle, comprising:
a surface register for fastening the outboard face to a barrel;
a floating register including vents to provide cooling to brake system components of the vehicle;
spokes joining the surface register and the floating register; and
a hub for fastening the wheel to the vehicle.

2. The outboard face of claim 1, wherein the barrel comprises an outboard rim that is coupled with an inboard rim.

3. The outboard face of claim 2, wherein the outboard rim and the inboard rim are separate components that are welded together to form the barrel.

4. The outboard face of claim 2, wherein the barrel is forged as a single component.

5. The outboard face of claim 1, wherein the outboard face is configured to be fastened onto a lip disposed around a perimeter of an inner surface of the barrel.

6. The outboard face of claim 1, wherein the surface register includes a multiplicity of threaded holes for mounting the outboard face onto the barrel.

7. The outboard face of claim 6, wherein the threaded holes are configured to receive hardware fasteners.

8. The outboard face of claim 1, wherein the spokes are configured to position the floating register farther outboard than the surface register so as to establish openings between the floating register and the surface register.

9. The outboard face of claim 8, wherein the openings provide fluid communication between the vents and openings between the spokes.

10. The outboard face of claim 8, wherein the vents are configured to cause the airflow through the openings to extract heated air from inside the barrel.

11. A floating register wheel for a vehicle, comprising:
a barrel for mounting a tire;
an outboard face for fastening the barrel to a wheel hub of a vehicle; and
vents disposed in a floating register to provide cooling to brake system components of the vehicle.

12. The floating register wheel of claim 11, wherein the barrel comprises an outboard rim that is coupled with an inboard rim.

13. The floating register wheel of claim 12, wherein the outboard rim and the inboard rim are separate components that are welded together to form the barrel.

14. The floating register wheel of claim 12, wherein the barrel is forged as a single component.

15. The floating register wheel of claim 11, wherein the outboard face is configured to be fastened onto a lip disposed around a perimeter of an inner surface of the barrel.

16. The floating register wheel of claim 11, wherein the outboard face includes a surface register that includes a multiplicity of threaded holes for mounting the outboard face onto the barrel.

17. The floating register wheel of claim 16, wherein the threaded holes are configured to receive hardware fasteners.

18. The floating register wheel of claim 11, wherein the outboard face includes a surface register for fastening the outboard face to a barrel; a floating register including vents to provide cooling to brake system components of the vehicle; spokes joining the surface register and the floating register; and a hub for fastening the wheel to the vehicle.

19. The floating register wheel of claim 18, wherein the spokes are configured to position the floating register farther outboard than the surface register so as to establish openings between the floating register and the surface register.

20. The floating register wheel of claim 19, wherein the openings provide fluid communication between the vents and openings between the spokes.

21. The floating register wheel of claim 19, wherein the vents are configured to cause the airflow through the openings to extract heated air from inside the barrel.
